(19) United States
(12) Patent Application Publication
(10) Pub. No.: US 2018/0357560 A1
(43) Pub. Date: Dec. 13, 2018

(54) AUTOMATIC DETECTION OF INFORMATION FIELD RELIABILITY FOR A NEW DATA SOURCE

(71) Applicant: Cisco Technology, Inc., San Jose, CA (US)

(72) Inventors: Andrea Di Pietro, Lausanne (CH); Grégory Mermoud, Veyras (CH); Sukrit Dasgupta, Norwood, MA (US); Jean-Philippe Vasseur, Saint Martin D'uriage (FR)

(21) Appl. No.: 15/620,116

(22) Filed: Jun. 12, 2017

(51) Int. Cl. G06N 99/00; H04L 12/26; G06N 5/04

(52) U.S. Cl. CPC G06N 99/005; G06N 5/04; H04L 43/06

(57) ABSTRACT

In one embodiment, a device identifies a new data source of characteristics data for a monitored network. The device initiates a quarantine period for the characteristic data from the new data source. The characteristic data from the new data source is quarantined from input to a machine learning-based analyzer during the quarantine period. The device models the characteristic data from the new data source during the quarantine period, to determine whether the characteristic data from the new data source is reliable for input to the machine learning-based analyzer. After the quarantine period, the device provides the characteristic data from the new data source to the machine learning-based analyzer based on a determination that the characteristic data from the new data source is reliable.

### TECHNICAL FIELD

The present disclosure relates generally to computer networks, and, more particularly, to the automatic detection of information field reliability for a new data source.

### BACKGROUND

Many network assurance systems rely on predefined rules to determine the health of the network. In turn, these rules can be used to trigger corrective measures and/or notify a network administrator as to the health of the network. For instance, in an assurance system for a wireless network, one rule may comprise a defined threshold for what is considered as an acceptable number of clients per access point (AP) or the channel interference, itself. More complex rules may also be created to capture conditions over time, such as a number of events in a given time window or rates of variation of metrics (e.g., the client count, channel utilization, etc.).

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example network assurance system;

FIGS. 4A-4D illustrate an example architecture for assessing characteristic data for a monitored network from a new data source;

FIG. 5A-5F illustrates examples of quarantining characteristic data from a new data source;

FIGS. 6A-6C illustrate examples of configuring a machine learning-based analyzer based on a reliability of input characteristic data; and

FIG. 7 illustrates an example simplified procedure for determining reliability of characteristic data regarding a monitored network from a new data source.

### DESCRIPTION OF EXAMPLE EMBODIMENTS

### Overview

According to one or more embodiments of the disclosure, a device identifies a new data source of characteristics data for a monitored network. The device initiates a quarantine period for the characteristic data from the new data source. The characteristic data from the new data source is quarantined from input to a machine learning-based analyzer during the quarantine period. The device models the characteristic data from the new data source during the quarantine period, to determine whether the characteristic data from the new data source is reliable for input to the machine learning-based analyzer. After the quarantine period, the device provides the characteristic data from the new data source to the machine learning-based analyzer based on a determination that the characteristic data from the new data source is reliable.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

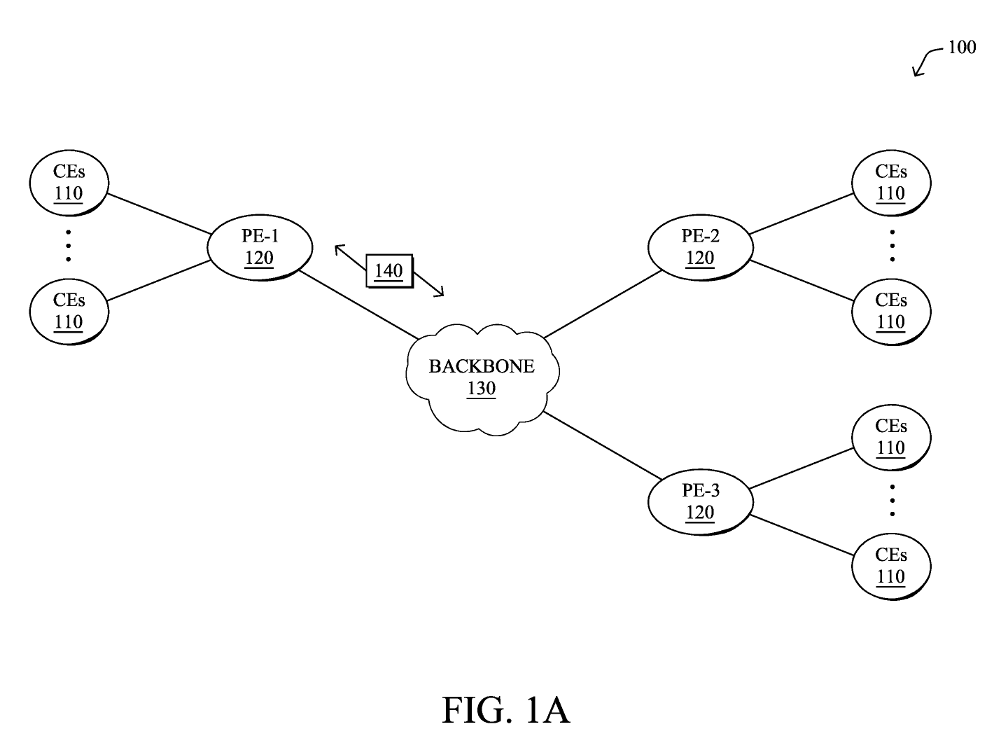

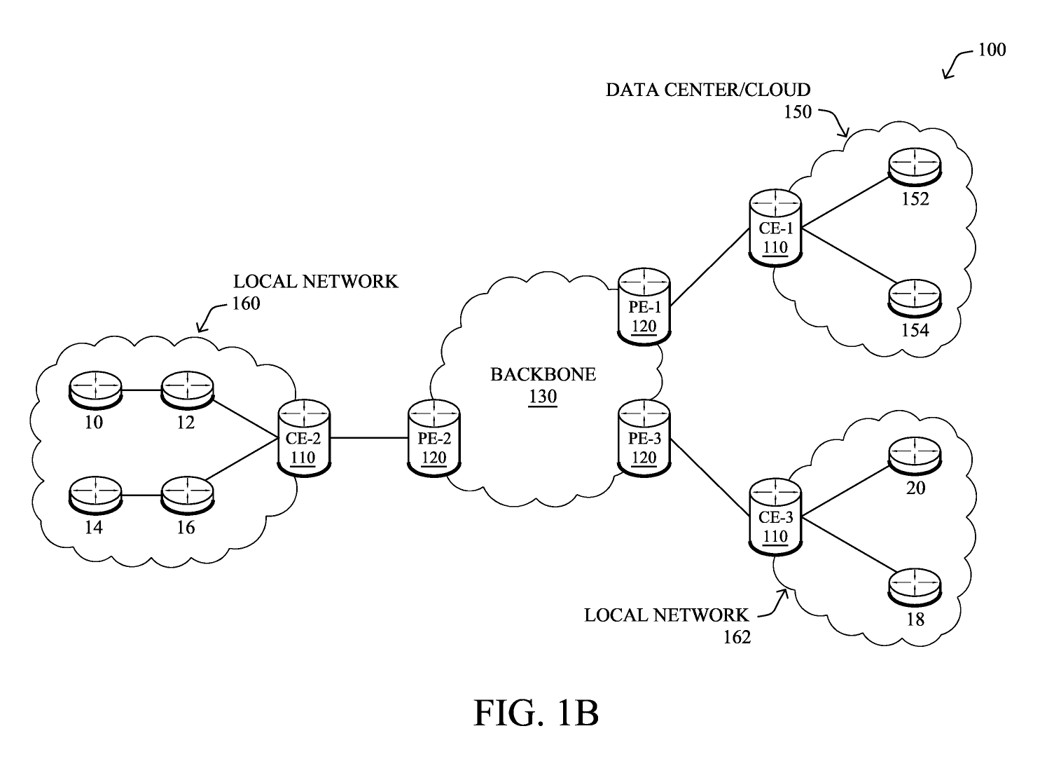

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

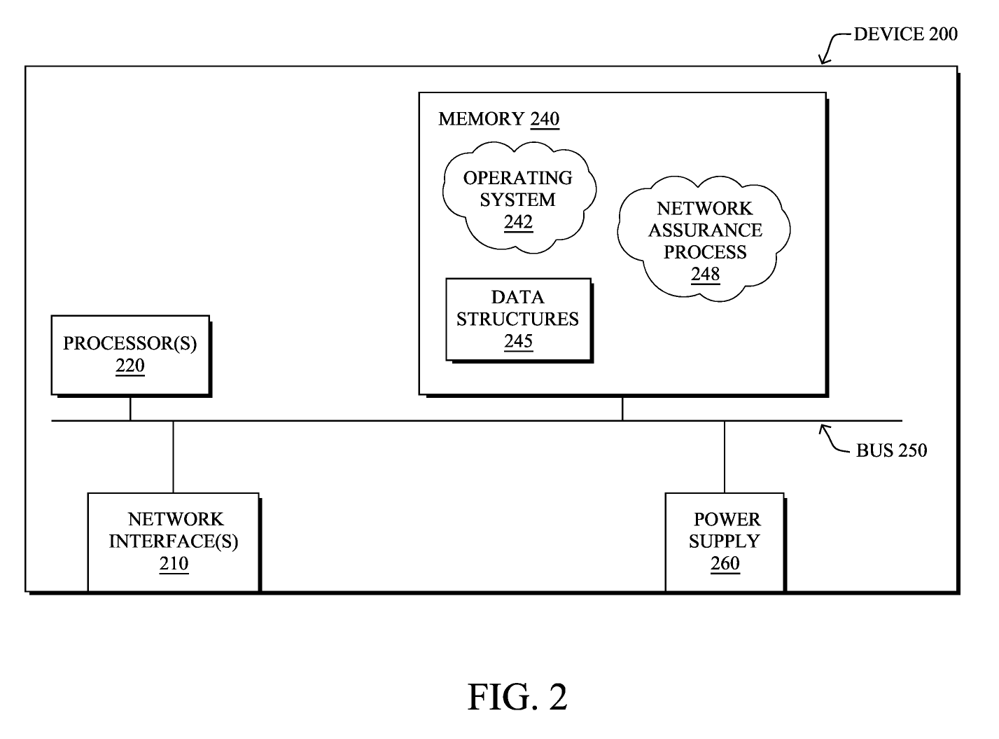

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a network assurance process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Network assurance process 248 includes computer executable instructions that, when executed by processor(s) 220, cause device 200 to perform network assurance functions as part of a network assurance infrastructure within the network. In general, network assurance refers to the branch of networking concerned with ensuring that the network provides an acceptable level of quality in terms of the user experience. For example, in the case of a user participating in a videoconference, the infrastructure may enforce one or more network policies regarding the videoconference traffic, as well as monitor the state of the network, to ensure that the user does not perceive potential issues in the network (e.g., the video seen by the user freezes, the audio output drops, etc.).

In some embodiments, network assurance process 248 may use any number of predefined health status rules, to enforce policies and to monitor the health of the network, in view of the observed conditions of the network. For example, one rule may be related to maintaining the service usage peak on a weekly and/or daily basis and specify that if the monitored usage variable exceeds more than 10% of the per day peak from the current week AND more than 10% of the last four weekly peaks, an insight alert should be triggered and sent to a user interface.

Another example of a health status rule may involve client transition events in a wireless network. In such cases, whenever there is a failure in any of the transition events, the wireless controller may send a reason_code to the assurance system. To evaluate a rule regarding these conditions, the network assurance system may then group 150 failures into different “buckets” (e.g., Association, Authentication, Mobility, DHCP, WebAuth, Configuration, Infra, Delete, De-Authorization) and continue to increment these counters per service set identifier (SSID), while performing averaging every five minutes and hourly. The system may also maintain a client association request count per SSID every five minutes and hourly, as well. To trigger the rule, the system may evaluate whether the error count in any bucket has exceeded 20% of the total client association request count for one hour.

In various embodiments, network assurance process 248 may also utilize machine learning techniques, to enforce policies and to monitor the health of the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, network assurance process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that network assurance process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

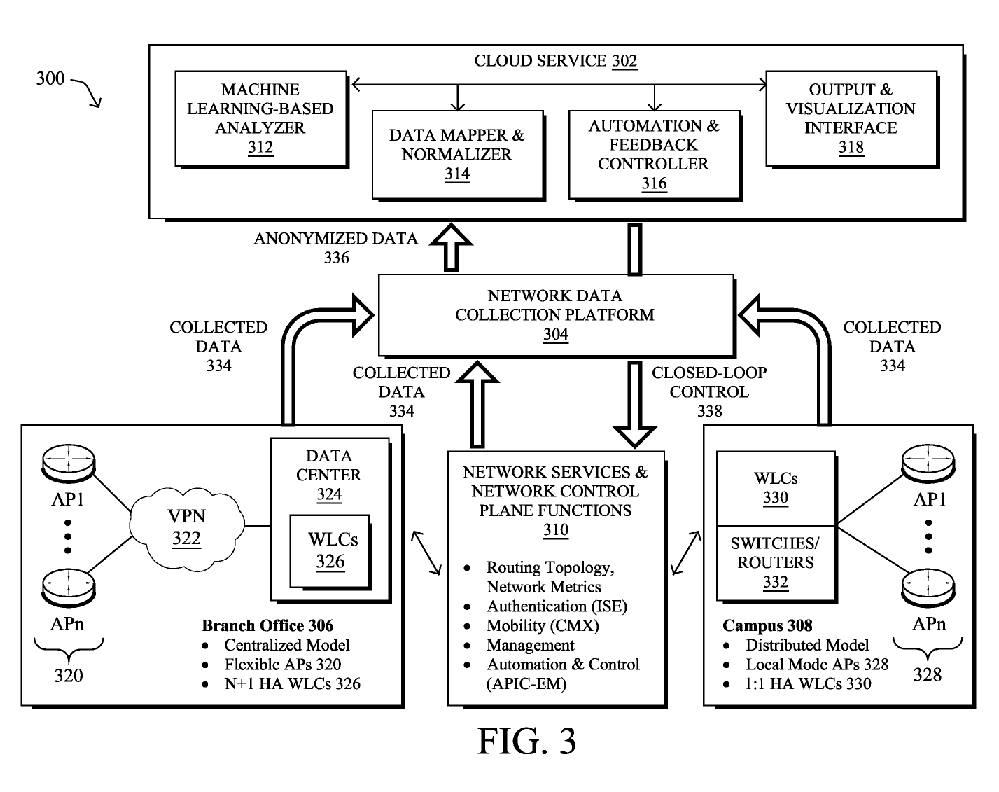

FIG. 3 illustrates an example network assurance system 300, according to various embodiments. As shown, at the core of network assurance system 300 may be a cloud service 302 that leverages machine learning in support of cognitive analytics for the network, predictive analytics (e.g., models used to predict user experience, etc.), troubleshooting with root cause analysis, and/or trending analysis for capacity planning. Generally, architecture 300 may support both wireless and wired network, as well as LLNs/IoT networks.

In various embodiments, cloud service 302 may oversee the operations of the network of an entity (e.g., a company, school, etc.) that includes any number of local networks. For example, cloud service 302 may oversee the operations of the local networks of any number of branch offices (e.g., branch office 306) and/or campuses (e.g., campus 308) that may be associated with the entity. Data collection from the various local networks/locations may be performed by a network data collection platform 304 that communicates with both cloud service 302 and the monitored network of the entity.

The network of branch office 306 may include any number of wireless access points 320 (e.g., a first access point AP1 through nth access point, APn) through which endpoint nodes may connect. Access points 320 may, in turn, be in communication with any number of wireless LAN controllers (WLCs) 326 located in a centralized datacenter 324. For example, access points 320 may communicate with WLCs 326 via a VPN 322 and network data collection platform 304 may, in turn, communicate with the devices in datacenter 324 to retrieve the corresponding network feature data from access points 320, WLCs 326, etc. In such a centralized model, access points 320 may be flexible access points and WLCs 326 may be N+1 high availability (HA) WLCs, by way of example.

Conversely, the local network of campus 308 may instead use any number of access points 328 (e.g., a first access point AP1 through nth access point APm) that provide connectivity to endpoint nodes, in a decentralized manner. Notably, instead of maintaining a centralized datacenter, access points 328 may instead be connected to distributed WLCs 330 and switches/routers 332. For example, WLCs 330 may be 1:1 HA WLCs and access points 328 may be local mode access points, in some implementations.

To support the operations of the network, there may be any number of network services and control plane functions 310. For example, functions 310 may include routing topology and network metric collection functions such as, but not limited to, routing protocol exchanges, path computations, monitoring services (e.g., NetFlow or IPFIX exporters), etc. Further examples of functions 310 may include authentication functions, such as by an Identity Services Engine (ISE) or the like, mobility functions such as by a Connected Mobile Experiences (CMX) function or the like, management functions, and/or automation and control functions such as by an APIC-Enterprise Manager (APIC-EM).

During operation, network data collection platform 304 may receive a variety of data feeds that convey collected data 334 from the devices of branch office 306 and campus 308, as well as from network services and network control plane functions 310. Example data feeds may comprise, but are not limited to, management information bases (MIBS) with Simple Network Management Protocol (SNMP) v2, JavaScript Object Notation (JSON) Files (e.g., WSA wireless, etc.), NetFlow/IPFIX records, logs reporting in order to collect rich datasets related to network control planes (e.g., Wi-Fi roaming, join and authentication, routing, QoS, PHY/MAC counters, links/node failures), traffic characteristics, and the like. As would be appreciated, network data collection platform 304 may receive collected data 334 on a push and/or pull basis, as desired. Network data collection platform 304 may prepare and store the collected data 334 for processing by cloud service 302. In some cases, network data collection platform may also anonymize collected data 334 before providing the anonymized data 336 to cloud service 302.

In some cases, cloud service 302 may include a data mapper and normalizer 314 that receives the collected and/or anonymized data 336 from network data collection platform 304. In turn, data mapper and normalizer 314 may map and normalize the received data into a unified data model for further processing by cloud service 302. For example, data mapper and normalizer 314 may extract certain data features from data 336 for input and analysis by cloud service 302.

In various embodiments, cloud service 302 may include a machine learning-based analyzer 312 configured to analyze the mapped and normalized data from data mapper and normalizer 314. Generally, analyzer 312 may comprise a power machine learning-based engine that is able to understand the dynamics of the monitored network, as well as to predict behaviors and user experiences, thereby allowing cloud service 302 to identify and remediate potential network issues before they happen.

Machine learning-based analyzer 312 may include any number of machine learning models to perform the techniques herein, such as for cognitive analytics, predictive analysis, and/or trending analytics as follows:
Cognitive Analytics Model(s): The aim of cognitive analytics is to find behavioral patterns in complex and unstructured datasets. For the sake of illustration, analyzer 312 may be able to extract patterns of Wi-Fi roaming in the network and roaming behaviors (e.g., the “stickiness” of clients to APs 320, 328, “ping-pong” clients, the number of visited APs 320, 328, roaming triggers, etc). Analyzer 312 may characterize such patterns by the nature of the device (e.g., device type, OS) according to the place in the network, time of day, routing topology, type of AP/WLC, etc., and potentially correlated with other network metrics (e.g., application, QoS, etc.). In another example, the cognitive analytics model(s) may be configured to extract AP/WLC related patterns such as the number of clients, traffic throughput as a function of time, number of roaming processed, or the like, or even end-device related patterns (e.g., roaming patterns of iPhones, IoT Healthcare devices, etc.).
Predictive Analytics Model(s): These model(s) may be configured to predict user experiences, which is a significant paradigm shift from reactive approaches to network health. For example, in a Wi-Fi network, analyzer 312 may be configured to build predictive models for the joining/roaming time by taking into account a large plurality of parameters/observations (e.g., RF variables, time of day, number of clients, traffic load, DHCP/DNS/Radius time, AP/WLC loads, etc.). From this, analyzer 312 can detect potential network issues before they happen. Furthermore, should abnormal joining time be predicted by analyzer 312, cloud service 312 will be able to identify the major root cause of this predicted condition, thus allowing cloud service 302 to remedy the situation before it occurs. The predictive analytics model(s) of analyzer 312 may also be able to predict other metrics such as the expected throughput for a client using a specific application. In yet another example, the predictive analytics model(s) may predict the user experience for voice/video quality using network variables (e.g., a predicted user rating of 1-5 stars for a given session, etc.), as function of the network state. As would be appreciated, this approach may be far superior to traditional approaches that rely on a mean opinion score (MOS). In contrast, cloud service 302 may use the predicted user experiences from analyzer 312 to provide information to a network administrator or architect in real-time and enable closed loop control over the network by cloud service 302, accordingly. For example, cloud service 302 may signal to a particular type of endpoint node in branch office 306 or campus 308 (e.g., an iPhone, an IoT healthcare device, etc.) that better QoS will be achieved if the device switches to a different AP 320 or 328.
Trending Analytics Model(s): The trending analytics model(s) may include multivariate models that can predict future states of the network, thus separating noise from actual network trends. Such predictions can be used, for example, for purposes of capacity planning and other “what-if” scenarios.

Machine learning-based analyzer 312 may be specifically tailored for use cases in which machine learning is the only viable approach due to the high dimensionality of the dataset and patterns cannot otherwise be understood and learned. For example, finding a pattern so as to predict the actual user experience of a video call, while taking into account the nature of the application, video CODEC parameters, the states of the network (e.g., data rate, RF, etc.), the current observed load on the network, destination being reached, etc., is simply impossible using predefined rules in a rule-based system.

Unfortunately, there is no one-size-fits-all machine learning methodology that is capable of solving all, or even most, use cases. In the field of machine learning, this is referred to as the “No Free Lunch” theorem. Accordingly, analyzer 312 may rely on a set of machine learning processes that work in conjunction with one another and, when assembled, operate as a multi-layered kernel. This allows network assurance system 300 to operate in real-time and constantly learn and adapt to new network conditions and traffic characteristics. In other words, not only can system 300 compute complex patterns in highly dimensional spaces for prediction or behavioral analysis, but system 300 may constantly evolve according to the captured data/observations from the network.

Cloud service 302 may also include output and visualization interface 318 configured to provide sensory data to a network administrator or other user via one or more user interface devices (e.g., an electronic display, a keypad, a speaker, etc.). For example, interface 318 may present data indicative of the state of the monitored network, current or predicted issues in the network (e.g., the violation of a defined rule, etc.), insights or suggestions regarding a given condition or issue in the network, etc. Cloud service 302 may also receive input parameters from the user via interface 318 that control the operation of system 300 and/or the monitored network itself. For example, interface 318 may receive an instruction or other indication to adjust/retrain one of the models of analyzer 312 from interface 318 (e.g., the user deems an alert/rule violation as a false positive).

In various embodiments, cloud service 302 may further include an automation and feedback controller 316 that provides closed-loop control instructions 338 back to the various devices in the monitored network. For example, based on the predictions by analyzer 312, the evaluation of any predefined health status rules by cloud service 302, and/or input from an administrator or other user via input 318, controller 316 may instruct an endpoint device, networking device in branch office 306 or campus 308, or a network service or control plane function 310, to adjust its operations (e.g., by signaling an endpoint to use a particular AP 320 or 328, etc.).

As noted above, a network assurance system may collect characteristic data for a monitored network from a large number of very heterogeneous sources, convert the data to a uniform data format, and use the converted data as input to its machine learning-based analyzer engines. Notably, the assurance system may receive the characteristic data via a number of different feeds (e.g., SNMP, WSA, Netflow, ISE, etc.), which are produced by network devices with different hardware/software versions.

Even if multiple devices claim that they implement the same standard-compliant API (e.g., they support the same SNMP MIB, etc.), some implementations can be buggy and provide corrupted data for particular kind of queries. In particular, testing has demonstrated that it is not infrequent to find devices returning SNMP counter values that are outside of the legitimate bounds which are expressed in the MIB definition. In this case, it is crucial to prevent this kind of information from being processed by the machine learning-based engine (e.g., analyzer 312), since this could generate invalid results that are usually extremely difficult to detect and fix. This is particularly important in case of non-linear supervised models being used (e.g. ANN), since their output is unpredictable in case their input falls within a region which was not represented in the training set.

One potential approach to unreliable data from the diverse set of data sources would be to:
1. manually test each network element from which the assurance system can potentially receive data,
2. verify whether a portion of the provided information is unreliable, and
3. generate a configuration for the data conversion and machine learning-based engines, which will prevent such unreliable information from affecting the results.

However, with a potentially large number of device versions to be supported, the above approach is hardly scalable, which can create a serious impairment for the goal of the system to be completely platform-agnostic.

Automatic Detection of Information Field Reliability for a New Data Source

The techniques herein introduce a mechanism to automatically detect the portions of information (e.g., characteristic data) about a monitored network that are not reliable for input to a machine learning-based analyzer. In some aspects, the mechanism tracks the reliability and availability of the data variables provided by different versions and types of data sources. In further aspects, the mechanism is also able to detect unreliable fields provided by a data source for which no a-priori information was available.

Specifically, according to one or more embodiments of the disclosure as described in detail below, a device identifies a new data source of characteristics data for a monitored network. The device initiates a quarantine period for the characteristic data from the new data source. The characteristic data from the new data source is quarantined from input to a machine learning-based analyzer during the quarantine period. The device models the characteristic data from the new data source during the quarantine period, to determine whether the characteristic data from the new data source is reliable for input to the machine learning-based analyzer. After the quarantine period, the device provides the characteristic data from the new data source to the machine learning-based analyzer based on a determination that the characteristic data from the new data source is reliable.

Illustratively, the techniques described herein may be performed by hardware, software, and/or firmware, such as in accordance with the network assurance process 248, which may include computer executable instructions executed by the processor 220 (or independent processor of interfaces 210) to perform functions relating to the techniques described herein.

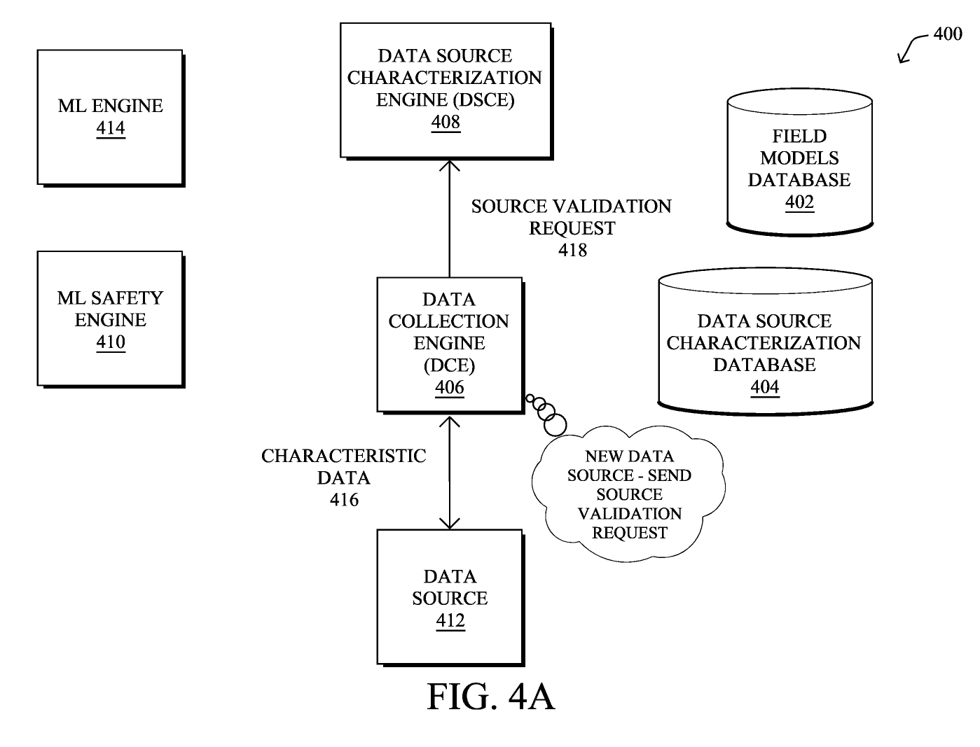

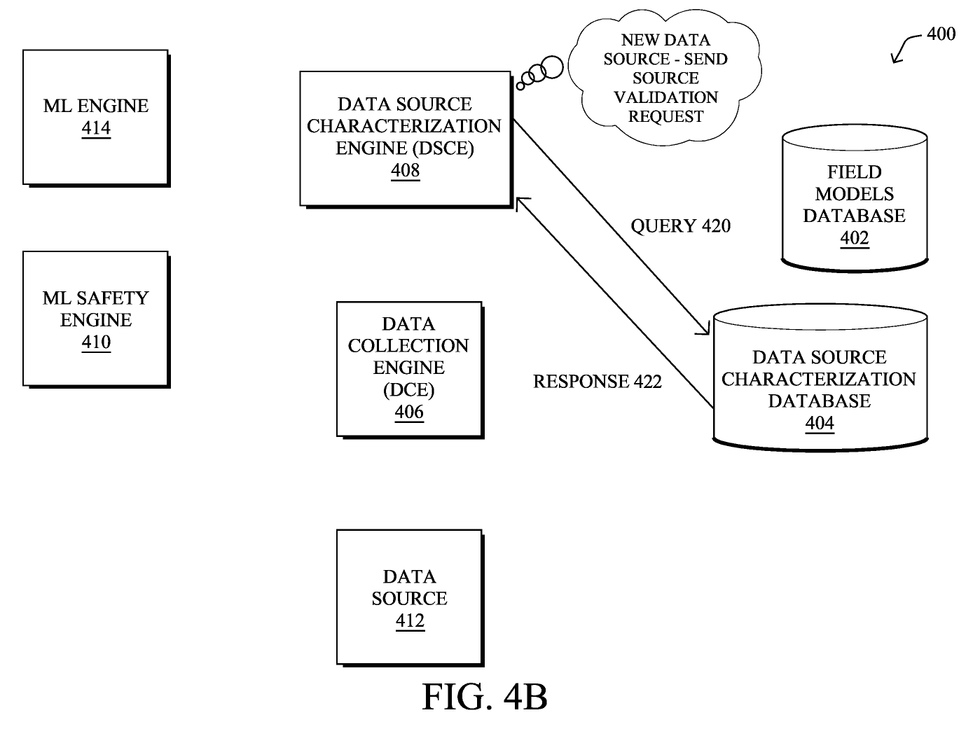

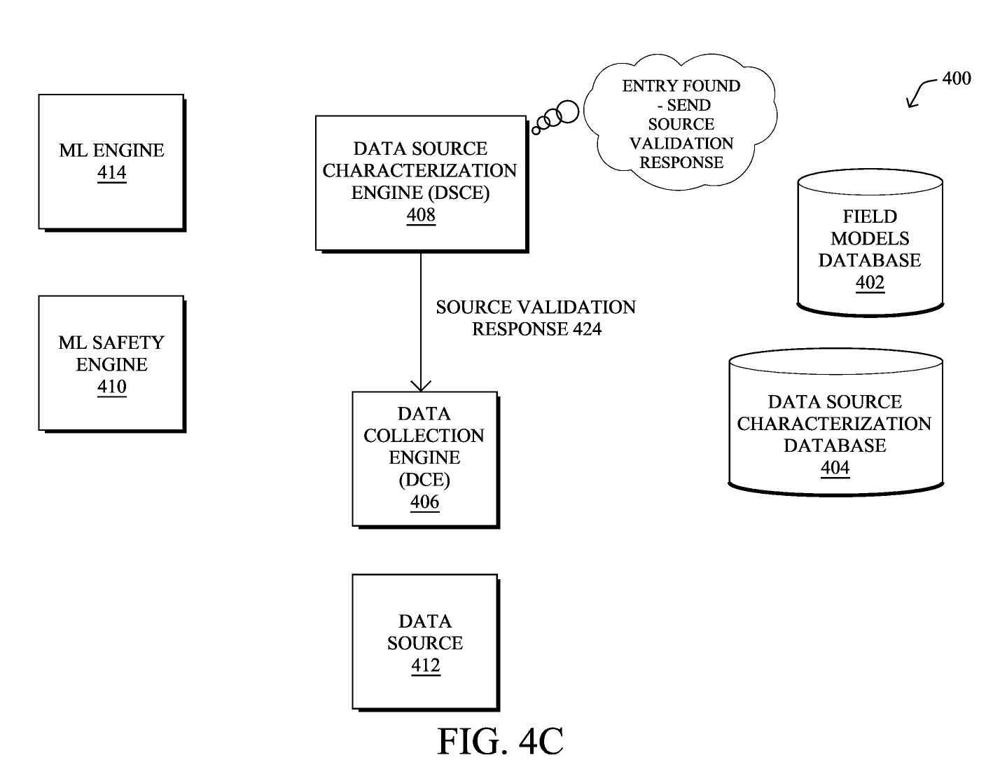

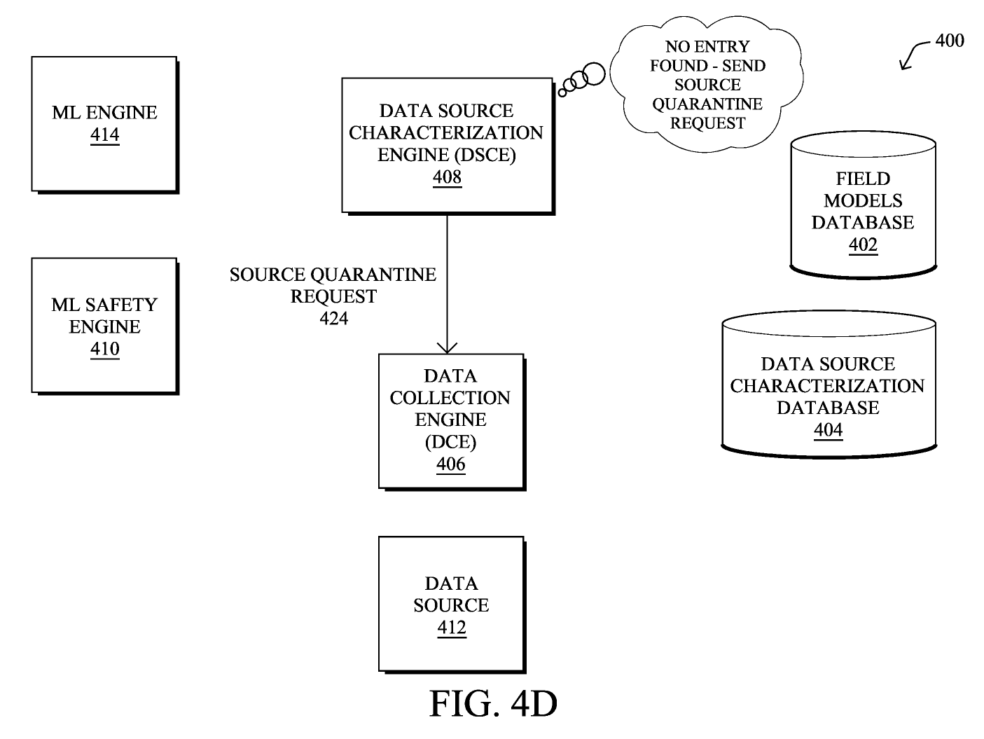

Operationally, FIGS. 4A-4D illustrate an example architecture 400 for assessing characteristic data for a monitored network from a new data source. As shown, architecture 400 may include any or all of the following components: a data source 412, a data collection engine (DCE) 406, a data source characterization engine (DSCE) 408, a machine learning (ML) safety engine 410, a ML engine 414, a field models database 402, and a data source characterization database 404. In various embodiments, architecture 400 may be implemented within a network assurance system, such as system 300 shown in FIG. 3. For example, data source 412 may be a network element in branch office 306 or campus 308, DCE 406 may be implemented as part of network data collection platform 304, while the other components may be implemented as part of cloud service 302. In further implementations, the components shown may be distributed across any of the different layers of network assurance system 300.

A first key element of architecture 400 is data source characterization database 404. Such a component is essentially a database that stores information characterizing the data provided by each possible data source for the network assurance system. In particular, for each device that is providing data to ML engine 414, database 404 may store any or all of the following properties of the data sources:
the hardware and software versions of the various network elements and other data sources;
the protocols used by the data sources to export information (e.g. Netflow, SNMP, etc.);
a list type of information fields that a particular source can reliably provide (e.g., which SNMP MIBs it implements, which Netflow records are supported, etc.);
a list of the information fields that the data source can provide, but that are not considered as reliable from a ML computation standpoint (e.g., SNMP variables with known implementation bugs, etc.).

In various embodiments, the above information stored by data source characterization database 404 can be dynamically inferred by architecture 400 from the reported characteristic data, every time a new source is detected. The task of dynamically populating such database is delegated to the second key component of architecture 400: DSCE 408.

As shown in FIG. 4A, when DCE 406 receives characteristic data 416 from a new data source 412, it may activate DSCE 408 by sending DSCE 408 a custom Source Validation Request message 418, including the address of the new data source 412 and, if needed, the credentials required in order to access it.

In one embodiment, the hardware/software version of the new data source 412 will be part of the configuration of DCE 406, which can then include such information as a part of the source validation request message 418. In another embodiment, such information will be inferred by DSCE 408 by examining the collected data (e.g. the SNMP system MIBs, etc.). DSCE 408 could also extract this information about specific versions for the different hardware and software components directly from the platform using only the connectivity details presented by DCE 406.

After determining the properties of new data source 412, such as its version and type, DSCE 408 may perform a lookup of these properties in data source characterization database 404, as shown in FIG. 4B. Notably, DSCE 408 may send a query 420 to database 404 that includes the properties of data source 412 and receive response 422 for further processing.

If an entry is found in database 404 for the specified source 412, DSCE 408 may respond to DCE 406 with a Source Validation Response message 424, as shown in FIG. 4C. Message 424 may include, for example, any of the retrieved data in response 422 from database 404, such as the list of reliable information fields which source 412 can provide and/or a list of the unreliable information fields. In response to receiving source validation response 424, DCE 406 may propagate such lists to ML safety engine 410, which is described in greater detail below.

As shown in FIG. 4D, an alternate case exists in which no entry is found in database 404 that matches the properties of data source 412. In such a case, DSCE 408 may instead respond to DCE 406 with a Source Quarantine Request message 426, thereby initiating a quarantine period for data source 412 during which characteristic data from data source 412 will not be used as input to ML engine 414.

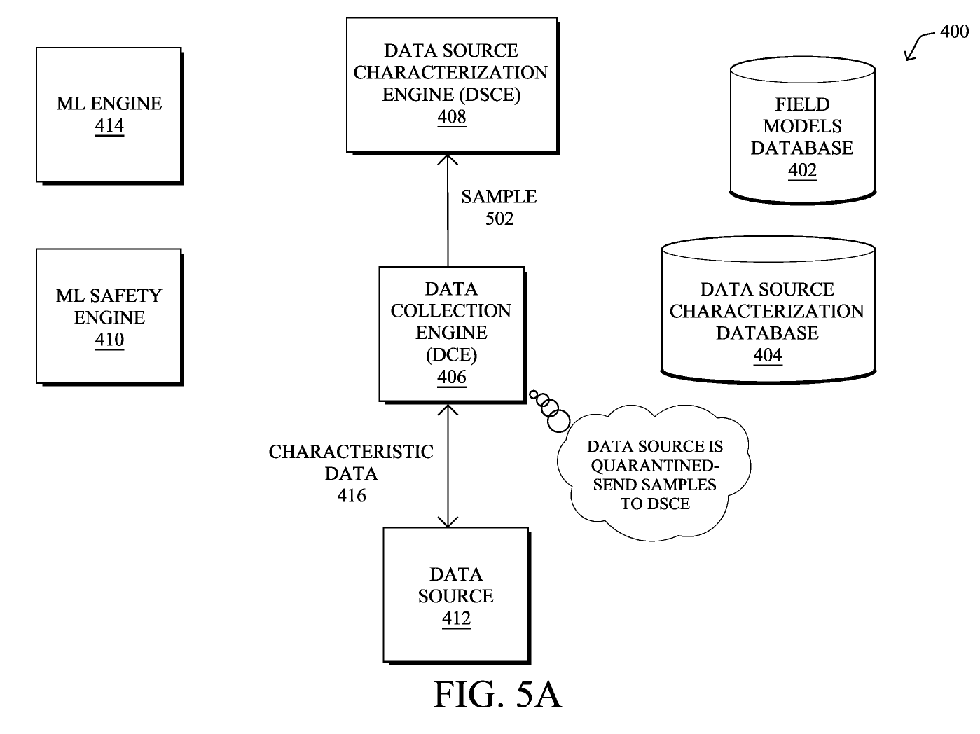

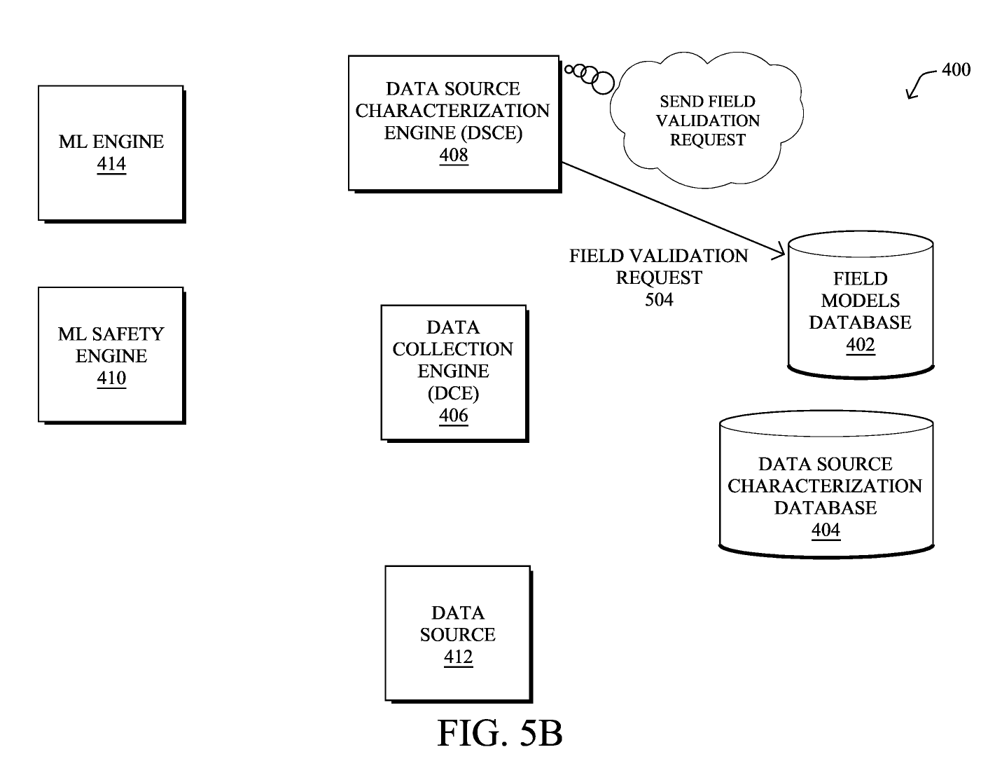

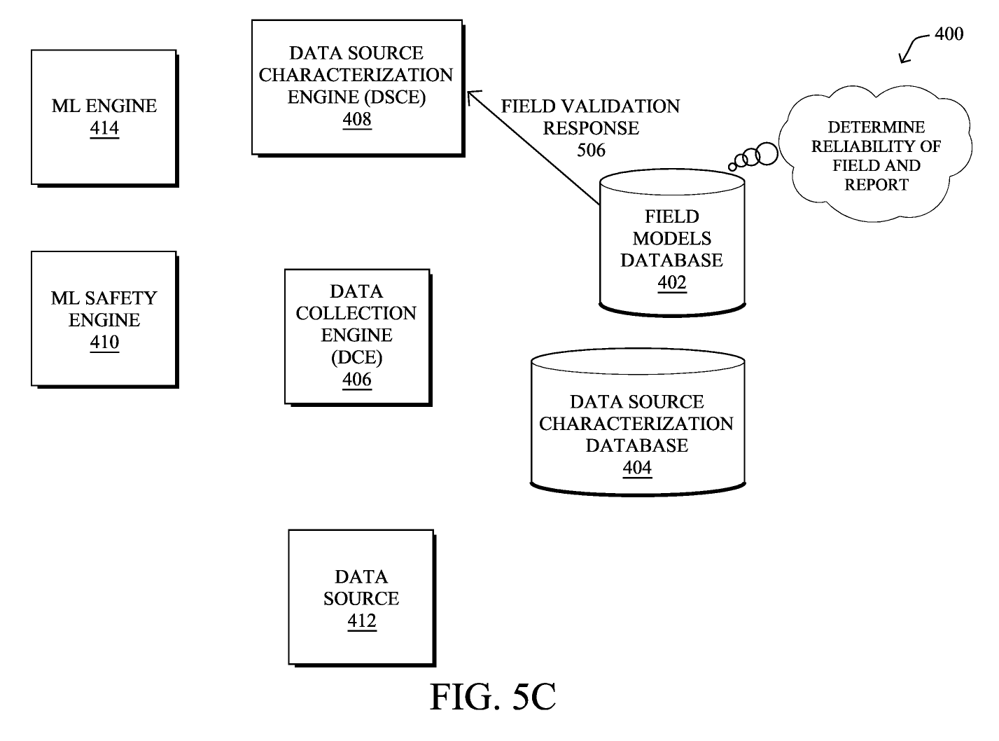

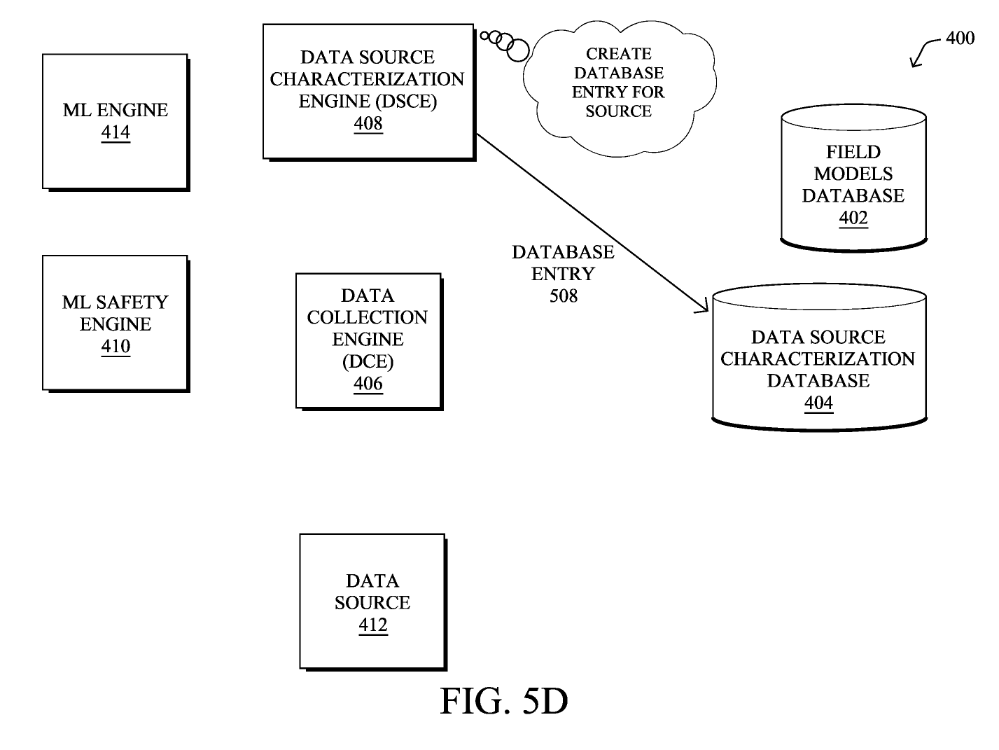

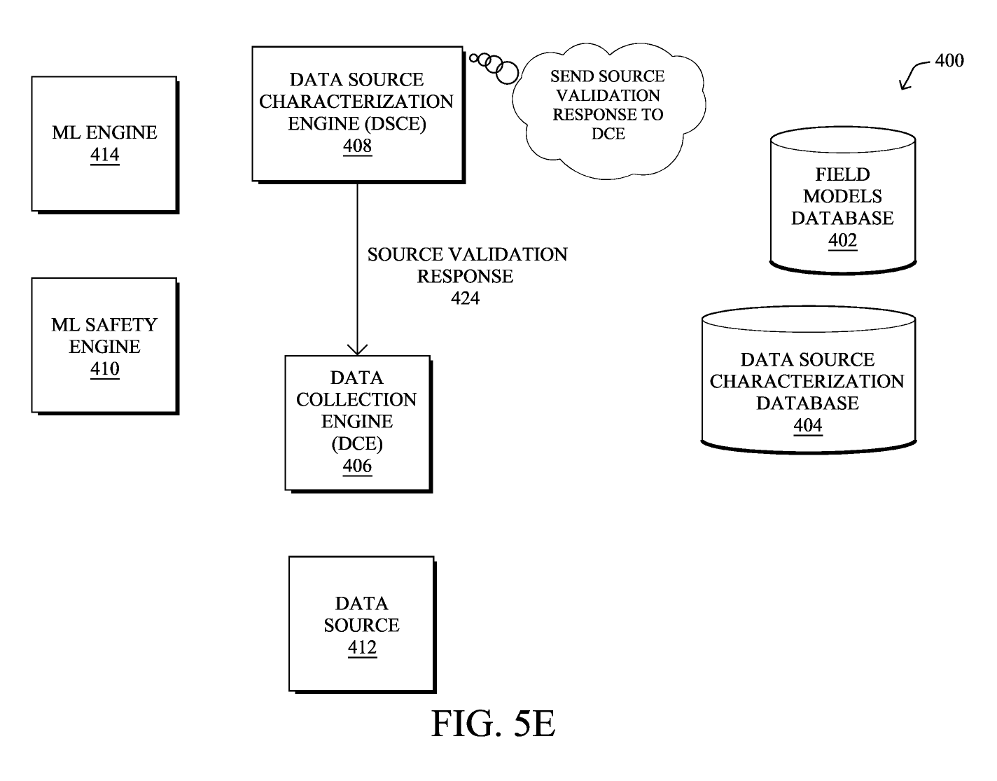

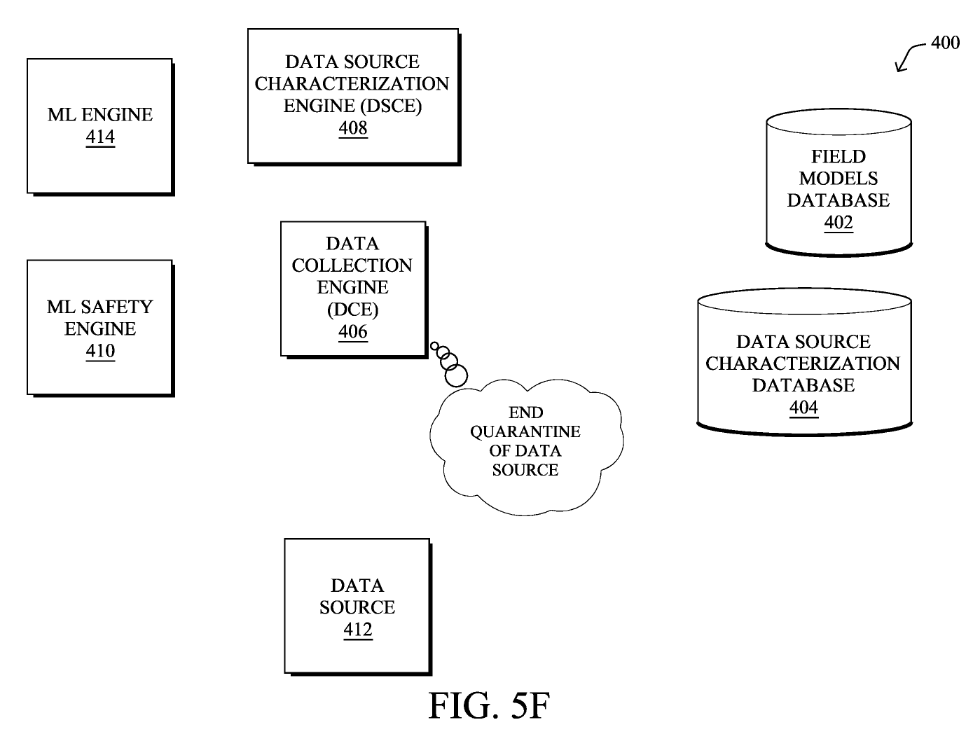

FIG. 5A-5F illustrates examples of quarantining characteristic data from a new data source, according to various embodiments. Continuing the example of FIGS. 4A-4D, if DSCE 408 sends a Source Quarantine Request message 426 indicating that a corresponding entry for data source 412 does not exist in data source characterization database 404, DCE 406 may send samples 502 of the characteristic data 416 from data source 412 to DSCE 408 for analysis, as shown in FIG. 5A. In other cases, DSC 406 may simply forward characteristic data 416 to DSCE 408, which then performs the sampling. During the quarantine period, DSC 406 may prevent the affected characteristic data 416 from being used as input to ML engine 414.

Note that a quarantine may be applied to the entire set of characteristic data produced by data source 412 or only to a subset thereof, in various cases. More specifically, it is possible that some software components or other properties of data source 412 have entries in data source characterization database 404, but others do not. For example, assume that data source 412 is using a new version of NBAR that has not been characterized in database 404, along with versions of SNMP MIBs and Netflow that have been characterized already. In such a scenario, architecture 400 may only quarantine the NBAR values from data source 412, while not quarantining the SNMP and Netflow field values. Doing so allows for a highly granular tracking of metric reliability which can then be leverage when heterogeneous software components are deployed together in a monitored network.

As shown in FIG. 5B, for each information field under quarantine, DSCE 408 may send samples of the data from data source 412 to field models database 402 as part of a Field Validation Request message 504. In various embodiments, database 402 is essentially a database storing a “validation model” for each of the information fields which can be processed by ML engine 414. In general, the particular model in database 402 will depend on the nature of the variable/field under quarantine. For numeric variables describing a configuration variable, for example, the model in database 402 can be as simple as a list of allowed values. For numeric variables, the model in database 402 can be a statistical distribution.

In another embodiment, a validation model in field models database 402 can capture the normal behavior of multiple variables, thus being able to detect whether reported variables are consistent (e.g., the counter of transmitted packets and transmitted bytes have to increase at the same time, etc.). In one embodiment, an anomaly detection (AD) technique, such as clustering or density estimation, can be used to detect that reported variables from a specific source are out of range compared to the values reported for the same variable by other nodes. In such a case, the data from the particular source can be deemed unreliable (e.g., untrustworthy) and prevented from being used as input to ML engine 414. In yet another embodiment, the model can represent the allowed transition of a state variable.

As shown in FIG. 5C, field models database 402 will respond to DSCE 408 with a Field Validation Response message 506 that reports on whether the particular information field, or combination of fields, is reliable. In another embodiment, Field Validation Response message 506 may include a request for the intervention of a human expert. In this case, the collected data will be displayed via a user interface (e.g., electronic display, etc.) to a system administrator, who will decide whether the content is reliable or not for processing by ML engine 414. As such, the human expert may provide a range of values via the interface that are considered as valid for the said variable. Such a range can then be used by field models database 402 to automatically filter reported values that may be suspicious.

At the end of the quarantine period, as shown in FIG. 5D, DSCE 408 may create an entry 508 in data source characterization database 404 for the field or fields of the quarantined characteristic data regarding the monitored network. Such an entry may, as discussed above, map properties of data source 412 to the fields or field of the characteristic data provided by data source 412, as well as an indication as to the reliability of these field for use as input to ML engine 414. Note that the reliability may be a simple binary indication (e.g., ‘reliable’ or ‘unreliable’) or, alternatively, a value on a sliding scale (e.g., ‘0’ is completely unreliable and ‘1’ is completely reliable, with decimal values allowed in between the two).

As shown in FIG. 5E, to terminate the quarantine period, DSCE 408 may send a Source Validation Response message 424 to DCE 406, which will include the information about the reliable and/or unreliable fields. Such a response will cause DCE 406 to put an end to the quarantine period for data source 412, thereby allowing at least the characteristic data deemed reliable to be used as input to ML engine 414, as shown in FIG. 5F.

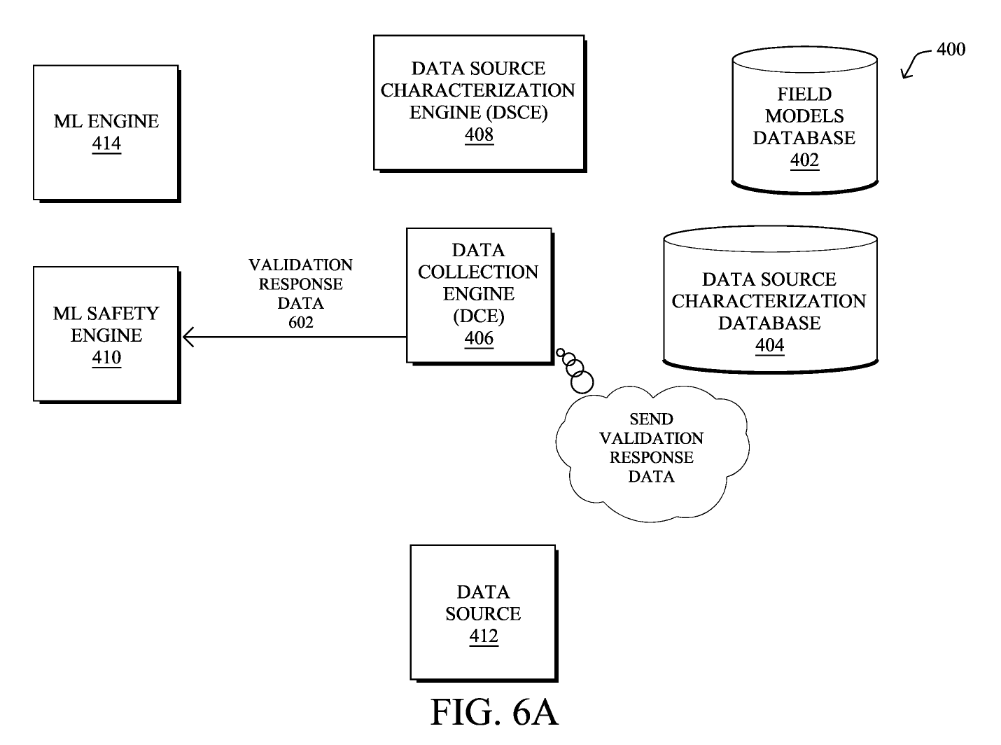

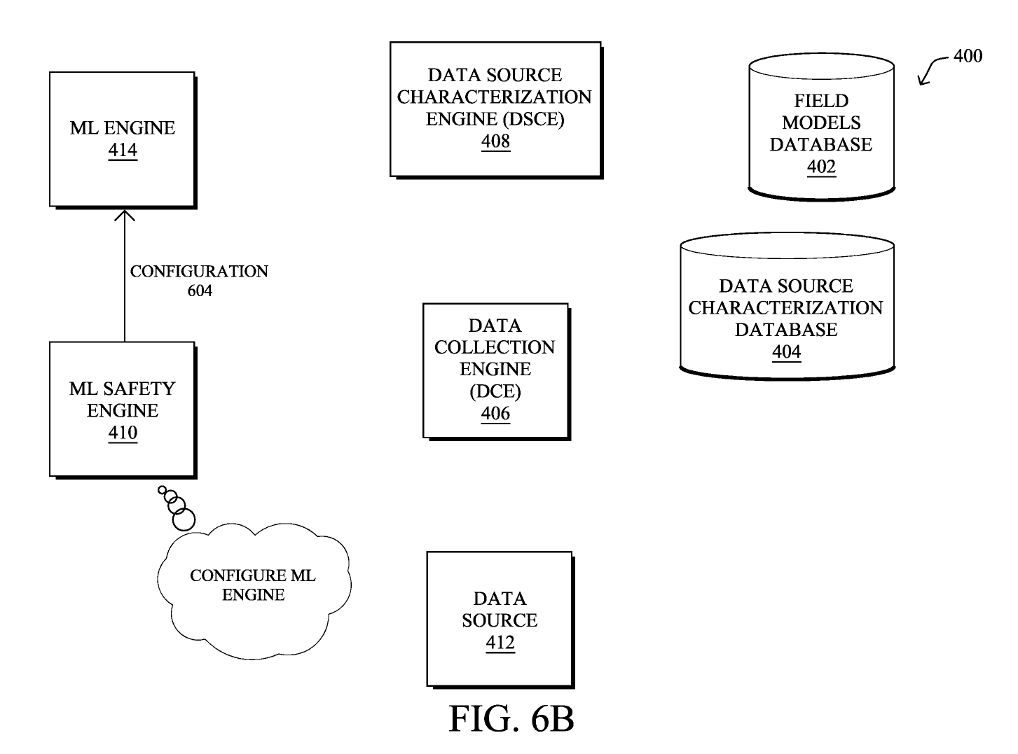

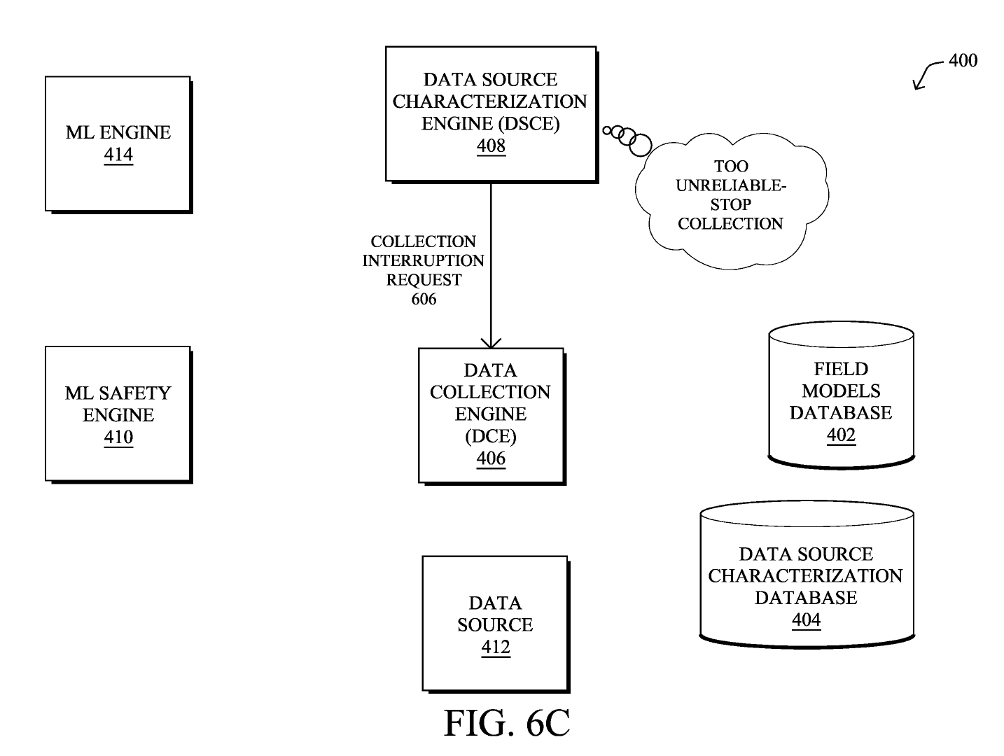

FIGS. 6A-6C illustrate examples of configuring a machine learning-based analyzer based on a reliability of input characteristic data, according to various embodiments. As mentioned earlier, DCE 406 may propagate the data 602 included in Source Validation Response message 424, either as a result of an initial hit in database 404 or as a result of a quarantine period, to ML safety engine 410, as illustrated in FIG. 6A. In various embodiments, ML safety engine 410 is in charge of configuring ML engine 414 that processes the characteristic data from a specific source, such as data source 412. In particular, ML safety engine 410 may disable all of the ML processes that relying on input characteristic data that is either missing (e.g., is not provided at all by data source 4112) or is deemed unreliable by architecture 400. In another embodiment, ML safety engine 410 may attribute lower weights in the ML computation of ML engine 414 to unreliable fields. In some cases, when the ML approach used by ML engine 414 supports missing or inaccurate data, ML safety engine 410 will provide a reliability index for each data source, as opposed to deactivating the corresponding ML mechanism. In doing so, the ML mechanism may give less importance to those features that are built from unreliable data sources, both for training and prediction.

In cases where the reliability index of a given characteristic field is so small that the retrieved data is of no use to ML engine 414, the collection of the corrupted fields can be stopped entirely by DCE 406, thus reducing the resources overhead of the data collection operation. For example, the system administrator can configure a lower bound for the reliability index, so that collection is automatically stopped for fields which are considered unreliable. In particular, as shown in FIG. 6C, this mechanism involves DSCE 408 sending a custom Collection Interruption Request message 606 to DCE 406. Such a message may include an indication of the fields which are considered to be unusable according to the corresponding source model(s) in database 402. Based on reception of such a message, DCE 406 will take appropriate actions depending on the nature of the data source. For SNMP fields, for example, DCE 406 will stop polling the associated column. For Netflow information elements, instead, DCE 406 will configure a new template of the source which will not include the corrupted fields.

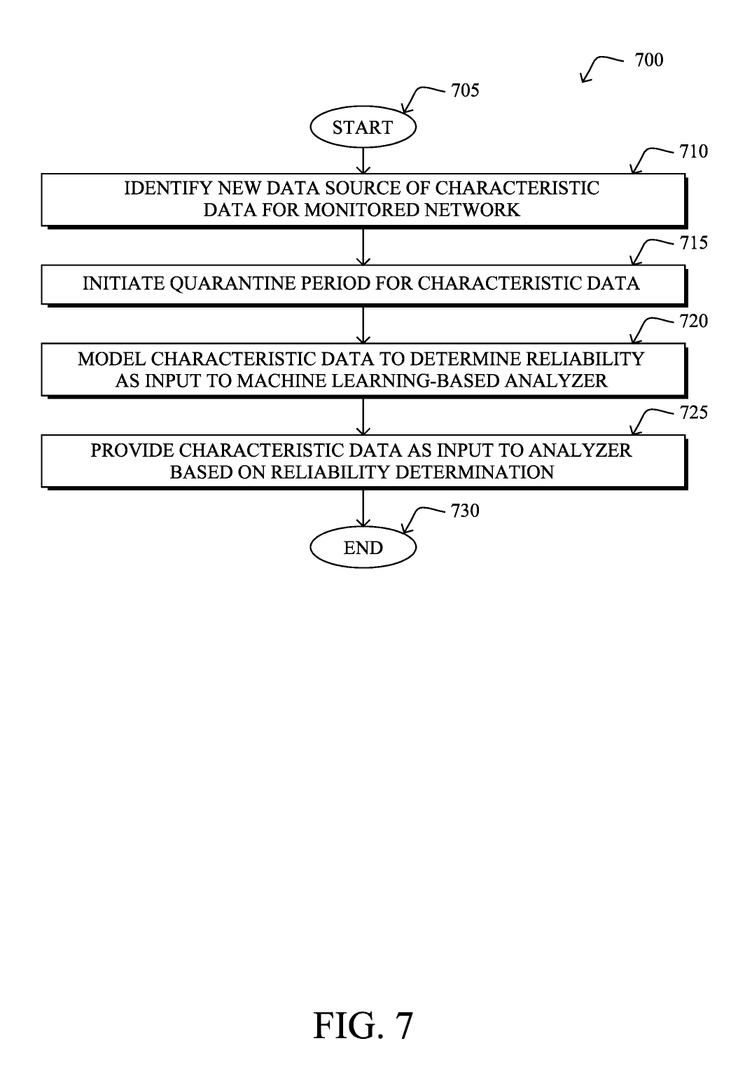

FIG. 7 illustrates an example simplified procedure for determining the reliability of characteristic data regarding a monitored network from a new data source, in accordance with one or more embodiments described herein. For example, a non-generic, specifically configured device (e.g., device 200) may perform procedure 700 by executing stored instructions (e.g., process 248). The procedure 700 may start at step 705, and continues to step 710, where, as described in greater detail above, the device may identify a new data source of characteristic data for a monitored network. Such a data source may be, for example, a network element in the monitored network. Accordingly, the characteristic data may be any form of data indicative of the state or operation of the network. For example, the characteristic data may include information regarding traffic in the monitored network (e.g., Netflow or IPFIX record information) or any other information that can be collected about the monitored network.

At step 715, as detailed above, the device may initiate a quarantine period for the characteristic data provided by the new data source. In some embodiments, if the one or more properties of the new data source (e.g., software and/or hardware versions, etc.) have not been fully characterized by the device, the device may initiate a quarantine period for the characteristic data from the data source. During this quarantine period, the characteristic data from the data source may not be used as input to a machine learning (ML)-based analyzer.

At step 720, the device may model the characteristic data from the new data source to determine whether the characteristic data from the new data source is reliable for input to the machine learning-based analyzer, as described in greater detail above. In some embodiments, the model may be an anomaly detection model. In another embodiment, the device may provide the characteristic data from the data source to a user interface and, in turn, receive an indication as to whether the characteristic data is unreliable (e.g., based on one or more ranges input by the user, etc.).

At step 725, as detailed above, the device may provide the characteristic data as input to the ML-based analyzer, based on a determination that the characteristic data from the new data source is reliable. For example, if the modeling of the characteristic data in step 720 indicates that the characteristic data is suitably reliable for input to an ML-based analyzer, the device may end the quarantine period and begin using the characteristic data as input. In some embodiments, the input data may be weighted according to a reliability index for the data, so as to give a higher rating to more reliable data. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for automatically tracking the kind of data provided by each possible data source for a network assurance system and to assess the reliability of this data for use as input to a machine learning-based analyzer. This allows unreliable data to be disabled from input to the analyzer, which could be negatively impacted by unreliable inputs.

While there have been shown and described illustrative embodiments that provide for determining whether characteristic data regarding a monitored network is reliable, it is to be understood that various other adaptations and modifications may be made within the spirit and scope of the embodiments herein. For example, while certain embodiments are described herein with respect to using certain models for purposes of analyzing the data regarding the monitored network, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
identifying, by a device, a new data source of characteristics data for a monitored network;
initiating, by the device, a quarantine period for the characteristic data from the new data source, wherein the characteristic data from the new data source is quarantined from input to a machine learning-based analyzer during the quarantine period;
modeling, by the device, the characteristic data from the new data source during the quarantine period, to determine whether the characteristic data from the new data source is reliable for input to the machine learning-based analyzer; and
providing, by the device and after the quarantine period, the characteristic data from the new data source to the machine learning-based analyzer based on a determination that the characteristic data from the new data source is reliable.

2. The method as in claim 1, wherein initiating the quarantine period for the characteristic data from the new data source comprises:
determining, by the device, that a model does not exist for the new data source based on one or more properties of the data source.

3. The method as in claim 2, wherein the one or more properties of the data source comprise at least one of: a hardware version of the data source, a software version of the data source, a protocol used by the data source, a data field exported by the data source as part of the characteristic data for the monitored network.

4. The method as in claim 1, further comprising:
sending, by the device, the characteristic data from the new data source to a user interface; and
receiving, at the device, an indication from the user interface as to whether the characteristic data is reliable.

5. The method as in claim 1, further comprising:
configuring, by the device, the machine learning-based analyzer to weight the characteristic data input to the analyzer based on a degree of reliability associated with the characteristic data.

6. The method as in claim 1, further comprising:
determining whether the characteristic data from the new data source is reliable for input to the machine learning-based analyzer using a range of values for the characteristic data that is deemed reliable.

7. The method as in claim 1, wherein modeling the characteristic data from the new data source during the quarantine period comprises:
applying, by the device, an anomaly detection model to the characteristic data from the new data source.

8. The method as in claim 1, wherein the new data source is a first data source, the method further comprising:
associating, by the device, one or more properties of the first data source with the determination that the characteristic data from the first data source is reliable; and
determining, by the device, that characteristic data for the monitored network from a second data source is reliable by matching one or more properties of the second data source to the one or more properties of the first data source.

9. The method as in claim 1, wherein the characteristic data for the monitored network comprises data regarding traffic in the monitored network.

10. An apparatus, comprising:
one or more network interfaces to communicate with a network;
a processor coupled to the network interfaces and configured to execute one or more processes; and
a memory configured to store a process executable by the processor, the process when executed configured to:
identify a new data source of characteristics data for a monitored network;
initiate a quarantine period for the characteristic data from the new data source, wherein the characteristic data from the new data source is quarantined from input to a machine learning-based analyzer during the quarantine period;
model the characteristic data from the new data source during the quarantine period, to determine whether the characteristic data from the new data source is reliable for input to the machine learning-based analyzer; and
provide, after the quarantine period, the characteristic data from the new data source to the machine learning-based analyzer based on a determination that the characteristic data from the new data source is reliable.

11. The apparatus as in claim 10, wherein the apparatus initiates the quarantine period for the characteristic data from the new data source by:
determining that a model does not exist for the new data source based on one or more properties of the data source.

12. The apparatus as in claim 11, wherein the one or more properties of the data source comprise at least one of: a hardware version of the data source, a software version of the data source, a protocol used by the data source, a data field exported by the data source as part of the characteristic data for the monitored network.

13. The apparatus as in claim 10, the process when executed further configured to:
send the characteristic data from the new data source to a user interface; and
receive an indication from the user interface as to whether the characteristic data is reliable.

14. The apparatus as in claim 10, the process when executed further configured to:
configure the machine learning-based analyzer to weight the characteristic data input to the analyzer based on a degree of reliability associated with the characteristic data.

15. The apparatus as in claim 10, the process when executed further configured to:
determine whether the characteristic data from the new data source is reliable for input to the machine learning-based analyzer using a range of values for the characteristic data that is deemed reliable.

16. The apparatus as in claim 10, wherein the apparatus models the characteristic data from the new data source during the quarantine period by:
applying an anomaly detection model to the characteristic data from the new data source.

17. The apparatus as in claim 10, wherein the new data source is a first data source, the process when executed further configured to:
associate one or more properties of the first data source with the determination that the characteristic data from the first data source is reliable; and
determine that characteristic data for the monitored network from a second data source is reliable by matching one or more properties of the second data source to the one or more properties of the first data source.

18. The apparatus as in claim 10, wherein the characteristic data for the monitored network comprises data regarding traffic in the monitored network.

19. A tangible, non-transitory, computer-readable medium storing program instructions that cause a device to execute a process comprising:
identifying, by the device, a new data source of characteristics data for a monitored network;
initiating, by the device, a quarantine period for the characteristic data from the new data source, wherein the characteristic data from the new data source is quarantined from input to a machine learning-based analyzer during the quarantine period;
modeling, by the device, the characteristic data from the new data source during the quarantine period, to determine whether the characteristic data from the new data source is reliable for input to the machine learning-based analyzer; and
providing, by the device and after the quarantine period, the characteristic data from the new data source to the machine learning-based analyzer based on a determination that the characteristic data from the new data source is reliable.

20. The computer-readable medium as in claim 19, wherein the characteristic data for the monitored network comprises data regarding traffic in the monitored network.
